(19) United States
(12) Patent Application Publication
(10) Pub. No.: US 2014/0265094 A1
(43) Pub. Date: Sep. 18, 2014

(54) DIE BONDER AND BONDING HEAD DEVICE OF THE SAME, AND ALSO COLLET POSITION ADJUSTING METHOD

(71) Applicant: HITACHI HIGH-TECH INSTRUMENTS CO., LTD., Kumagaya-shi (JP)

(72) Inventors: Hideharu KOBASHI, Kumagaya-shi (JP); Keisuke NADAMOTO, Kumagaya-shi (JP); Yoshihisa NAKAJIMA, Kumagaya-shi (JP)

(73) Assignee: HITACHI HIGH-TECH INSTRUMENTS CO., LTD., Kumagaya-shi (JP)

(21) Appl. No.: 14/025,612

(22) Filed: Sep. 12, 2013

(30) Foreign Application Priority Data
Mar. 15, 2013 (JP) 2013-054171

(51) Int. Cl. B25B 11/00; B23Q 3/18

(52) U.S. Cl. CPC B25B 11/005; B23Q 3/186
USPC 269/21; 356/399

(57) ABSTRACT

For providing a die bonder, a bonding head device and a collet position adjusting method for enabling an automatic correction (adjustment) of errors, including height and inclination thereof, when exchanging a collet, with a simple structure thereof, in the bonding head device, having a holder 41h for guiding a vacuum for suction in an inside thereof, a shank 41s and a collet 41c, detachably attached at a tip of the holder, for adjusting the position of the collet after exchange of the collet, a reverse-side surface of that collet is photographed, before exchanging it, by a reverse-side surface photographing camera 42, which is disposed below the bonding head device, and after the exchange of the collet, the reverse-side surface of that collet exchanged, and then correction is made on positions of the collets, so that pictures photographed before/after the exchange thereof come to be coincident with.

Bonding This application relates to and claims priority from Japanese Patent Application No. 2013-54171 filed on Mar. 15, 2013, the entire disclosure of which is incorporated herein by reference.

### BACKGROUND OF THE INVENTION

The present invention relates to a die bonder and a bonding head device, being able to adjust the position of a collet for sucking a die, i.e., a semiconductor chip, to be attached at a tip of a bonding head, and further relates to a collet position adjusting method in that device.

As an example of a semiconductor manufacturing apparatus, the die bonder for mounting the die (i.e., the semiconductor chip) for example, on a printed circuit board or a lead frame, i.e., so-called a substrate, thereby assembling a package, as a product, includes a bonding process for bonding on the substrate. In such bonding process, it is necessary to bond the die, correctly, on a bonding surface of the substrate, and for that purpose, positioning and inspection are made through photographing the die and the substrate (i.e., a measurement target) by means of a camera, and through video processing of that video or picture (for example, in comparison with a reference, which is determined in advance).

In general, the bonding head for sucking the die comprises a holder, being in one body with a bonding head unit of a main body of the die bonder, and being hollow for guiding a vacuum for suction into an inside thereof, a shank, also being hollow, to be attached at a tip of that holder, and further a collet to be attached at the tip of that shank, being made of a elastic material, such as, a rubber, etc. Further, the collet is formed into a shape corresponding to that of the die to be sucked thereon, and in a part thereof is formed a through-hole for guiding the vacuum to that suction surface.

For that reason, in general, both the shank and the collet mentioned above include such mechanisms that they are exchangeable depending on the difference of a size, etc., of the die to be produced. In more details, each part of those is configured in a block form, for example, so that it can be inserted but without mistaking in the direction of attachment thereof.

Among of those, in particular, the collet touches down on the surface of the die, when it picks up the die from a wafer, and at that time, it receives a pressure. Thereafter, the vacuum is guided through the through-holes, which are formed along central axes of the holder, the shank and the collet, and through so-called an inner-air suction, handling is made on the die. Thus, with movement of the bonding head, the die sucked is transferred onto the substrate. This die transferred touches down on the substrate, and it receives a load (for example, from several N to several tens N) for bonding thereon, in the vertical direction, from the bonding head. Thus, repetition of such processes by the die bonder enables mass production of the products.

For that reason, the collet made of the rubber, etc., is gradually deformed (i.e., crunched), through the repetition of the processes mentioned above, and it must be exchanged by a new one when a number of the productions manufactured thereby reaches to a certain amount. When exchanging that collet, it is replaced by a collet itself or as a unit with the shank; however in that instance, an error (i.e., unsteadiness) is generated in a connecting portion between the exchanged collet and the collet, or between the shank and the collet. Thus, when an exchanging operation is conducted thereon, then mainly due to the reason(s) mentioned above, the new collet is not attached at the position completely same to that of the replaced one; i.e., the position of the collet after the exchange thereof is shifted, and an amount thereof (i.e., an offset amount) reaches from several μm up to several tens μm.

Then, conventionally, for example, in the following Patent Document 1 is already known a technology for conducting an automatic correction of attachment error of the collet, depending on an automatic detection of the attachment error of the collet with respect to the bonding head, upon basis of the difference between the positions when before it is picked up and after it is picked up, while a specific die on an adhesive tape is turned back to an original position on the adhesive tape, after being picked up by the collet, which is supported on the bonding head through a supporting axis, once.

Also, in the following Patent Document 2 is already known a technology for correcting bonding coordinates by an eccentricity correction volume, for the purpose of correcting eccentricity of an axis of the collet, wherein a picture at the tip of the collet in a home position is displayed on a CCD camera, and a cursor of the picture, which is taken before rotation, is adjusted to a center of a chip suction surface; thereby inputting a center position before the rotation. Next, the collet at 0 degree is turned round up to the position of 180 degrees, the picture taken after the rotation, which is obtained by the CCD camera, is displayed on a monitor, and also the cursor displayed thereon is adjusted to the chip suction surface; thereby inputting the center position after the rotation. And, then, after calculating a center of the rotation of the collet holder through obtaining an imaginary circle from each center position, and also calculating a shifting volume in the X direction and a shifting volume in the Y direction, at the center position before the rotation and the center position after the rotation, those are converted into the boding coordinates so as to calculate the eccentricity correction volume.

However, in those conventional technologies mentioned above, for the purpose of avoiding changing of size of an image, which is formed, depending a fluctuation of distance between the die, i.e., the measurement target, and the substrate, normally, it is common to apply a so-called a telecentric lens (i.e., a lens, a condensed light beam thereof is in parallel with an optical axis thereof, and the size of the image does not change even if the distance between the measurement target fluctuates), as an optical system of the camera for photographing.

### PRIOR ART DOCUMENTS

### Patent Documents

[Patent Document 1] Japanese Patent Laying-Open No. 2003-68772 (2003); and
[Patent Document 2] Japanese Patent Laying-Open No. 2006-142388 (2006).

### BRIEF SUMMARY OF THE INVENTION

However, with those conventional technologies mentioned above, although a technology is already known, for automatically conducting the correction of the attachment error of the collet with applying the CCD camera, etc., when exchanging the collet; however, for automatically conducting the correction (or adjustment), including the position (in particular, height in the vertical direction) and/or an inclination (in particular, an inclination of the suction surface) of the collet after the exchange thereof, there is further necessity of other sensor(s) and correction mechanism(s), and this brings about a problem of increasing of a manufacturing cost of the manufacturing apparatus, etc.

Then, according to the present invention, being accomplished by taking the problem(s) of those conventional technologies mentioned above into the consideration thereof, in more specifically, an object thereof is to provide a die bonder, for enabling to conduct the automatic correction (or, adjustment), when exchanging the collet (i.e., the unsteadiness), including the height and/or the inclination thereof, with a simple structure, but without accompanying the increase of manufacturing const thereof, and a bonding head device for the same, and further a method for adjusting the collet position.

According to the present invention, for accomplishing the object mentioned above, there is provided a collet position adjusting method for adjusting a position of a collet after exchange thereof, in a boding head apparatus having, at least, a holder for guiding a vacuum for suction in an inside thereof, and a collet, which is attached at a tip of said holder in a detachable manner, comprising the following steps of: photographing a reverse-side surface of said collet by a reverse-side surface photographing unit, an optical system of which is constructed with a non-telecentric lens, being disposed below said bonging head apparatus, before exchanging said collet; photographing the reverse-side surface a collet exchanged, by said reverse-side surface photographing unit, after exchanging said collet; and correcting a position of said collet, so that pictures photographed by said reverse-side surface photographing unit, the optical system of which is constructed with said non-telecentric lens, before and after exchange thereof, come to be coincident with.

Also, according to the present invention, for accomplishing the object mentioned above, there is provided a bonding head device, comprising, at least: a holder for guiding a vacuum for suction in an inside thereof; and a collet, which is attached at a tip of said holder in a detachable manner, wherein a reverse-side surface photographing unit for photographing a reverse-side surface of said collet is further provided below said bonding head apparatus.

Further, also for accomplishing the object mentioned above, according to the present invention, there is provided a die bonder, for mounting a die at a predetermined position on a substrate, comprising: a bonding head device, which is configured to mount said die, by sucking said die at a tip thereof to hold and moving to the predetermined position on said substrate mounted on a stage; a moving mechanism, which is configured to move said bonding heat device; and a controller apparatus, which is configured to mount said die at the predetermined position on said substrate mounted, by controlling each of operations of at least said bonding head device and said moving mechanism, and further comprising a photographing unit, which is configured to make positioning of a measurement target, including said die or/and said substrate therein, before and after mounting of said die is conducted by said bonding head device, wherein said bonding head device has a holder for guiding a vacuum for suction in an inside thereof, and a collet, which is attached at a tip of said holder in a detachable manner, and further is provided a reverse-side surface photographing unit for photographing a reverse-side surface of said collet, below said bonding head device, and said reverse-side surface photographing unit is constructed with a lens system, including a non-telecentric lens therein as an optical system thereof.

With such present invention as mentioned above, there can be obtained a superior effect of providing the die bonder, for enabling to conduct the automatic correction (or, adjustment), when exchanging the collet (i.e., the unsteadiness), including the height and/or the inclination thereof, with a simple structure, but without accompanying the increase of manufacturing const thereof, and the bonding head device for the same, and further the method for adjusting the collet position.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is an entire view of an outlook of a die bonder, according to an embodiment of the present invention;

FIG. 2 is a perspective view for showing an outlook structure of a boding head portion to conduct a die bonding process for mounting a die on a substrate, in the structure of the die bonder mentioned above;

FIGS. 3A and 3B are partial enlarged cross-section views for showing the detailed structure of the bonding head mentioned above, including a collet therein;

FIG. 4 is an exploded perspective view for showing the structure of a reverse-side surface photographing camera for photographing a reverse-side surface of the collet in the bonding head portion mentioned above;

FIGS. 5A and 5B are explanatory views for explaining pictures of the collet differing from in the position where it is photographed by a non-telecentric lens, which is applied in the reverse-side surface photographing camera;

FIG. 6 is an explanatory view for explaining about the picture of the collet inclined, which is photographed by the non-telecentric lens, which is applied in the reverse-side surface photographing camera; and

FIG. 7 is flowchart for showing an example of an automatic attachment error correction (i.e., a collet position adjusting method) when exchanging the collet, according to the present invention.

### DETAILED DESCRIPTION OF THE PREFERRED EMBODIMENTS

Hereinafter, embodiments according to the present invention will be fully explained by referring to the attached drawings.

FIG. 1 shows an example of applying the present invention into a die bonder, in particular, as one embodiment thereof. However, this FIG. 1 is an outlook view of the die bonder 10 when seeing it from above, and as is apparent from that figure, the die bonder 10 comprises, roughly separating, a wafer supply portion 1, a substrate supply/transfer portion 5, a die bonding portion 3, and a controller portion 4 for controlling those.

The wafer supply portion 1 has a wafer set lifter 11 and a pickup apparatus 12. The wafer set lifter 11 has a wafer cassette (not shown in the figure) filled up with wafer rings therein, and supply a wafer ring to the pickup apparatus 12, successively. The pickup apparatus 12 moves the wafer ring in such a manner that a desired die can be picked up from the wafer ring.

The substrate supply/transfer portion 5 has a stack loader 51, a frame feeder 52, an un-loader 53. The stack loader 51 supplies a substrate (for example, a lead frame) to be attached with the die thereon. The frame feeder 52 transfers the substrate to the un-loader 53, passing through two (2) sets of processing positions on the frame feeder 52. The un-loader 53 keep the substrates transferred therein.

The die bonding portion 3 has a pre-form portion 31 and a bonding head portion 32. The pre-form portion 31 applies a die adhesive agent on the substrate transferred by the frame feeder 52. The bonding head portion 32 goes up while picking up the die by means of a bonding head 41, and moves the die up to a bonding point on the frame feeder 52. And, the bonding head portion 32 brings the die to go down at the bonding point, and thereby bonding the die on the substrate, on which the die adhesive agent is applied.

FIG. 2 is a perspective view for showing an outlook configuration of the bonding head portion 32 for conducting a die bonding process, in the die bonder 10 mentioned above.

The bonding head portion 32 has the bonding head 41 so suck the die “D” for the bonding thereof, a camera (not shown in the figure) for photographing the lead frame and the die mounted thereon, so as to conduct the positioning of the lead frame “S”, i.e., the substrate, and thereby to mount (or bond) the die picked up at a predetermined position on the surface of that substrate, a fixing base 43 for supporting or fixing the bonding head 41 thereon, a moving mechanism 47 for moving the fixing base 43 into X and Y directions, and a bonding stage (hereinafter, being called by only “stage”) 44 for holding the lead frame “S” thereon. Further, a reference numeral 52 depicts a frame feeder for forming the substrate supply/transfer portion 5 for transferring the lead frame “S”.

The bonding head 41 has a collet 41c for sucking/holding the die “D” at the tip thereof, and a two (2) dimensional (hereinafter, “2-D”) moving mechanism 41m, for bringing the collet 41c to go up (i.e., move in a Z-direction), and also for brining the collet 41c in a Y-direction) with respect to the fixing base 43. Also, below the bonding head 41 is provided a reverse-side photographing camera 42 for photographing the reverse-side surface of the collet (i.e., the suction surface onto the die), the details of which will be mentioned later.

Further, the controller portion 4 mentioned above comprises, though not shown in the figure herein, a control/calculation portion made of a CPU, for example a memory device, including RAM (i.e., a main memory device) and/or HDD (i.e., an auxiliary memory device) therein, a touch panel, a mouse, a video taking-in device (i.e., a video capture board), a motor controller apparatus, a display device, such as, a liquid crystal panel, etc., and an input/output controller device, including an I/O signal controller device (i.e., sensor/switch control, etc.), and inputs signals receiving from various kinds of cameras (not shown in the figure) including the reverse-side photographing camera 42 mentioned above and/or from each of those portions, and controls the operation of each of those portions mentioned above.

Following to the above, explanation will be given hereinafter, on the operations or functions of a so-called bonding head device, including the collet 41c, etc., the reverse-side surface of which (i.e., the suction surface onto the die) is photographed by the reverse-side photographing camera 42 mentioned above, being distinctive feature according to the present invention, in other words, the bonding head 41 and the reverse-side photographing camera 42 mentioned above, in details thereof, by referring to FIGS. 3A and 3B and FIG. 4 attached herewith.

First of all, FIGS. 3A and 3B show the detailed structure of a tip portion of the bonding head device, including the collet 41c, which builds up that bonding head. Thus, as is apparent from the figure, it comprises, for example, a cylinder-like holder 41h for introducing a vacuum for sucking the die, which is supplied from a vacuum source not shown in the figure, a shank 41s to be attached at the tip of that holder 41h, fixedly, by a fixing means, such as, a screw 412, etc., and the collet 41c to be attached on a lower end surface of that shank 41s, which is made of an elastic material, such as, a rubber, etc., for example. Also, in general, the shank 41s and the collet 41c have such structures that they can be exchanged, appropriately, depending on the shape and the size of the die to be sucked. For example, each of those parts is configured into such a form that it can be inserted, but without mistaking in the direction of attachment thereof.

In particular, the collet 41c mentioned above, being made of the rubber, touches down on the die and receives the pressure on the suction surface thereof, when it picks up the die from the wafer, as was mentioned previously. Thereafter, it sucks the die by means of the vacuum supplied through openings, which are formed along central axes of the holder 41h, the shank 41s and the collet 41c (see FIG. 3B), so as to handle the die sucked thereon. Thus, with movement of the bonding head, the die “D” is transferred on the substrate “S” (see FIG. 2).

Thereafter, the die “D” transferred touches down on the substrate “S”; but at that time, since receiving a load (normally, from several N to several tens N) for bonding, in the vertical direction, applied by the bonding head, and such a process is repeated thereafter, then the collet is deformed (i.e., crunched), gradually, and it is necessary to be exchanged by a new one when the production reaches to a certain amount of degrees.

And, when conducting such exchange, it is conducted by a unit of the collet 41c itself, or as one body together with the shank 41s; but at that instance, an error (i.e., unsteadiness) is generated in a connecting portion between the exchanged collet and the collet, or between the shank and the collet.

Next, FIG. 4 shows therein the outline configuration of the reverse-side photographing camera 42 mentioned above, although not showing the detailed lens structure thereof, but it comprises a lens system 422 combining a single or plural number of pieces of lenses within a body of a cylinder-like housing 421, and a plane-like video sensor (for example, a CCD sensor or a CMOS sensor, etc.) 423 for forming an image of a measurement target on a detection surface thereof through that lens system, and thereby taking out the video (or picture) in the form of an electric signal.

Thus, in the die bonder according to the present invention, with disposition of the reverse-side photographing camera 42 having such configuration as mentioned above, below the bonding head 41, it is possible to photograph the suction surface of the collet 41c, i.e., a reverse-side surface of the collet 41c (or, as the unit together with the shank 41s).

Further, according to the present invention, in particular, the lens system 422 for building up the reverse-side photographing camera 42 mentioned above is configured with, not the so-called telecentric lens(es), i.e., the lens, the condensed light beam thereof is in parallel with an optical axis thereof, and the size of the image does not change even if the distance between the measurement target fluctuates, but a non-telecentric lens(es) (also, may be called, “a non-telecentric system”). Further, the non-telecentric lens(es) mentioned in the present invention means a lens(es) is/are that/those having less telecentricity, such as, a CCTV lens or a micro lens(es), for example. Also, the operation of such telecentric lens(es) will be also explained, hereinafter, by referring to FIGS. 5A and 5B attached herewith.

FIGS. 5A and 5B explain the photographing operation of the non-telecentric lens(es), which is applied in the present invention, and in particular, FIG. 5A shows the case where the position of the collet 41c (i.e., the position of the suction surface thereof) is close to (i.e., low), while FIG. 5B shows the case where the position of the collet 41c is far from (i.e., high), respectively, in comparison thereof, with respect to the reverse-side photographing camera 42. Also, in those figures, the pictures P and P′, which are photographed by that reverse-side photographing camera 42, are shown at the lower right portion of each figure.

Thus, as is shown in those figures, within the reverse-side photographing camera 42, which builds up the optical system thereof with the non-telecentric lens(es) (or, the non-telecentric system), an image of the suction surface of the collet 41c, i.e., the measurement target, on the plane-like video sensor 423. In that instance, in accordance with the non-telecentric lens(es), the size of an obtainable image comes to be large in case where the position of the collet 41c is close to (i.e., low), on the other hand, the size of the obtainable image comes to be small in case where the position of the collet 41c is far from (i.e., high). Thus, according to the reverse-side photographing camera 42 applying the non-telecentric lens(es) as the optical system thereof, the position of the collect 41c can be seen, depending on the size of the image obtained.

In more details thereof, if the size (in particular, the size of the suction surface) of the collet 41c to be attached or exchanged is known, in advance, it means that the positional coordinates (in particular, the Z-axis) of that collet can be seen from that, with respect to the camera 42. With utilizing such characteristics, an automatic exchange of the collet can be achieved, by adjusting the position thereof (i.e., the height=Z-axis) so that the pictures of the collet, which are photographed before/after the exchange thereof, come to the same size thereof, when exchanging the collet.

Also, FIG. 6 shows the picture of the collet 41c, when it is attached with an inclination thereof. Thus, the picture of the collet having a square outer shape, for example, results to generate a change in the length of each side thereof. However, in such case, it is apparent for the person skilled in the art, that also the automatic exchange of the collet can be achieved, by adjusting an inclination angle “θ” so that the pictures of the collet, which are photographed before/after the exchange thereof, come to the same position and the same size thereof.

Following to the above, explanation will be given about an automatic attachment error correction (i.e., a collet position adjusting method) when exchanging the collet, in the bonding head device or the die bonder mentioned above, according to the present invention, in more details thereof, by referring to a flowchart shown FIG. 7 attached herewith. However, this processing is executed by the CPU (not shown in the figure), which builds up the controller portion 4 mentioned above (see FIG. 1), for example.

First of all, when exchanging the collet, at a predetermined position (i.e., a position before exchange of the collet), such as, a waiting position of the collet, etc., for example, the reverse-side surface of an old collet to be exchanged is taken or photographed by the reverse-side photographing camera 42, and the picture photographed is memorized in the memory device (i.e., the HDD (the auxiliary memory device)), etc., for example (S71). Thereafter, an operator conducts an operation of exchanging the collet (S72).

Thereafter, again, the suction surface of a new collet, which was exchanged, is photographed by reverse-side photographing camera 42 (S73) (may be memorized in the memory device, once, in that instance), and it is compared with the picture of the suction surface of the old collet, which was already memorized, through the video processing, etc., to correct the bonding head 41, at least of the height (in the Z-axis) and/or the inclination angle (θ) thereof, so that the suction surface of the new collet comes to same to the suction surface of the old collet; thereby completing a series of collet exchange operation. However, in that instance, it is enough to do the correction in such a manner that the collets photographed come to be same to each other, in the contours thereof. Further, this correction (or adjustment) on the collet positions is executed by the CPU building up the controller portion mentioned above, through the moving mechanism of the bonding head 14.

In this manner, with the bonding head device according to the present invention, it is possible to conduct the correction, automatically, upon the errors when exchanging the collet, including the height and the inclination thereof, easily, with a relatively simple structure thereof, and also to suppress a great increase of the manufacturing cost of the manufacturing apparatus.

In the mentioned above, although the explanation was given on the embodiment of the present invention; however, various kinds of alternative examples, modifications and variations thereof are possible, upon basis of the explanation given in the above, for the person skilled in the art, and the present invention includes those various kinds of alternative examples, modifications and variations thereof, within a breadth, but not departing from a spirit of thereof.

What is claimed is:

1. A collet position adjusting method for adjusting a position of a collet after exchange thereof, in a boding head apparatus having, at least, a holder for guiding a vacuum for suction in an inside thereof, and a collet, which is attached at a tip of said holder in a detachable manner, comprising the following steps of:
photographing a reverse-side surface of said collet by a reverse-side surface photographing unit, an optical system of which is constructed with a non-telecentric lens, being disposed below said bonging head apparatus, before exchanging said collet;
photographing the reverse-side surface a collet exchanged, by said reverse-side surface photographing unit, after exchanging said collet; and
correcting a position of said collet, so that pictures photographed by said reverse-side surface photographing unit, the optical system of which is constructed with said non-telecentric lens, before and after exchange thereof, come to be coincident with.

2. A bonding head device, comprising, at least:
a holder for guiding a vacuum for suction in an inside thereof; and
a collet, which is attached at a tip of said holder in a detachable manner, wherein
a reverse-side surface photographing unit for photographing a reverse-side surface of said collet is further provided below said bonding head apparatus.

3. A die bonder, for mounting a die at a predetermined position on a substrate, comprising:
a bonding head device, which is configured to mount said die, by sucking said die at a tip thereof to hold and moving to the predetermined position on said substrate mounted on a stage;
a moving mechanism, which is configured to move said bonding heat device; and
a controller apparatus, which is configured to mount said die at the predetermined position on said substrate mounted, by controlling each of operations of at least said bonding head device and said moving mechanism, and further comprising
a photographing unit, which is configured to make positioning of a measurement target, including said die or/and said substrate therein, before and after mounting of said die is conducted by said bonding head device, wherein
said bonding head device has a holder for guiding a vacuum for suction in an inside thereof, and a collet, which is attached at a tip of said holder in a detachable manner, and further is provided a reverse-side surface photographing unit for photographing a reverse-side surface of said collet, below said bonding head device, and
said reverse-side surface photographing unit is constructed with a lens system, including a non-telecentric lens therein as an optical system thereof.
